(19) United States
(12) Patent Application Publication
(10) Pub. No.: US 2005/0183332 A1
(43) Pub. Date: Aug. 25, 2005

(54) Monolithic metal plant container

(76) Inventors: Marc Gerald Montry, Dallas, TX (US); Heath Charles MacDonald, Dallas, TX (US)

Correspondence Address: TIMOTHY F. LOOMIS, 14309 AUTUMN CREST DRIVE, BOYDS, MD, 20841, US

(21) Appl. No.: 10/765,603

(22) Filed: Jan. 28, 2004

(51) Int. Cl. A01G 9/02

(52) U.S. Cl. 47/65.7

(57) ABSTRACT

A monolithically constructed metal plant container suitable for containing plants with aggressive root systems, such as bamboo. The plant container is constructed through a mold-injection process using heated liquid metal, such as aluminum. The container has at least one external wall forming an exterior, and at least one interior wall and at least one bottom wall at least partially forming a cavity for holding the root structure of the plant. A slot(s) and/or hole(s) may be provided in the at least one bottom wall to facilitate drainage of excess water from the container.

### FIELD OF THE INVENTION

The present invention relates to a monolithically constructed metal plant container especially useful for holding plants with aggressive growth root systems, such as many species of bamboo.

### BACKGROUND OF THE INVENTION

Bamboo has been long admired for its fast growth and dense foliage. These characteristics may make bamboo seem ideal for erecting natural privacy barriers. However, the use of bamboo in landscaping, garden and patio applications has been limited due to its extremely aggressive root system.

The root systems of bamboo species, if not contained, generally lead to uncontrollable growth. These root systems of fast growing bamboo species are so aggressive that they will effectively and completely destroy traditional containers made of pottery, concrete or plastic. When planted in the ground, such species overrun boundaries unless deep and substantial barriers are entrenched prior to planting.

One desiring to plant bamboo, must then invest a great deal of time and money in entrenching a barrier system to contain the plants or risk the wild overgrowth of their landscape with bamboo and/or shattered planters.

Thus, there is a need for a relatively low-cost plant container capable of effectively containing aggressive root system plants, such as bamboo.

### SUMMARY OF THE INVENTION

The present invention relates to a monolithically constructed metal plant container suitable for containing plants with aggressive root systems, such as bamboo. The plant container is constructed through a mold-injection process using heated liquid metal, such as aluminum. The container has at least one external wall, at least one interior wall and at least one bottom wall. The at least one bottom wall and the at least one interior wall at least partially defining a cavity for holding the root structure of the plant. A slot(s) and/or hole(s) may be provided in the at least one bottom wall to facilitate drainage of excess water from the container.

The present invention has many advantages over the prior art and other possible containers. It provides a container capable of holding the root structure of aggressive growth plants, such as bamboo, without jeopardizing the destruction of the container itself, unlike ceramic, plastic or concrete plant containers. It facilitates the planting of bamboo both indoors and outdoors and in patio situations in a relatively inexpensive fashion, unlike entrenched barriers. Furthermore, it requires less labor to manufacture than a bent metal, welded metal or a riveted metal container, resulting in a lower manufacturing cost and a more aesthetically pleasing container.

An embodiment of the present invention relates to a monolithically constructed metal plant container having at least one external wall at least partially forming an exterior, and at least one internal wall and at least one bottom wall at least partially forming a cavity for holding a plant's root structure.

Another embodiment of the present invention provides a monolithically constructed metal plant container having two external walls and two end walls, two internal walls and two bottom walls, the two internal walls, the two external walls and two end walls forming an exterior and the two bottom walls and two end walls forming a cavity for holding a plant's root structure.

As such, it is an object of the present invention to provide for a monolithic metal plant container capable of holding the root structure of an aggressive growth plant.

It is another object of the present invention to provide for a monolithic metal plant container having an exterior and a cavity for holding the root structure of a plant.

### BRIEF DESCRIPTION OF THE DRAWINGS

FIG. 1 is a sectional view of a monolithically constructed metal plant container according to an embodiment of the present invention.

FIG. 2 is elevation view of a monolithically constructed metal plant container according to an embodiment of the present invention.

FIG. 3 is a top view of a monolithically constructed metal plant container according to an embodiment of the present invention.

FIG. 4 is a sectional view of a monolithically constructed metal plant container according to another embodiment of the present invention.

FIG. 5 is a footprint diagram of the footprints of a plurality of monolithically constructed metal plant containers according to yet another embodiment of the present invention.

### DESCRIPTION OF THE PREFERRED EMBODIMENTS

The present invention will be better understood by reference to the accompanying drawings.

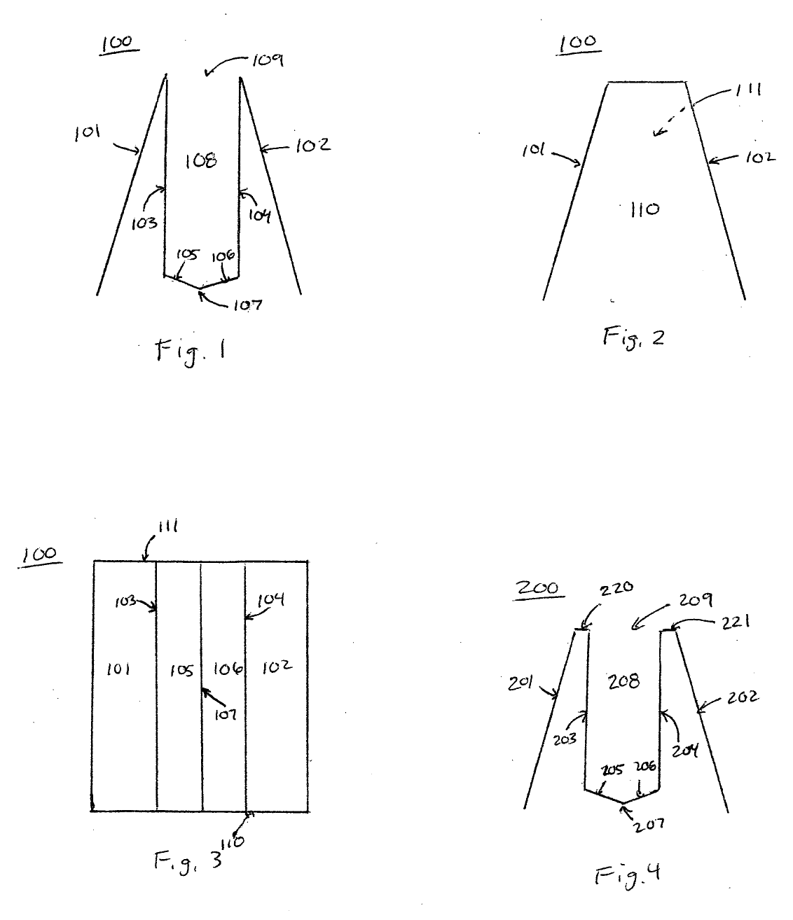

Referring now to FIG. 1, a sectional view of an embodiment of a monolithically constructed metal plant container 100 is shown. Plant container 100 has exterior walls 101 and 102. These walls are preferably not vertical, but inclined from the vertical towards the center as one moves up from the bottom of plant container 100, as shown. With the heights that bamboo plants reach, they can become “top heavy”, especially in windy conditions. By having walls 101 and 102 offset from vertical, it creates a larger base for plant container 100 and therefore provides stability.

Plant container 100 also has interior walls 103 and 104. In this embodiment, interior walls 103 and 104 are connected directly to exterior walls 101 and 102. These interior walls are preferably slightly offset from the vertical away from the center, for example on the order of about 3 degrees. This slight offset aids in removal of plant container 100 from the mold during construction. Bottom walls 105 and 106 are provided attached to walls 103 and 104, respectively. Walls 105 and 106 should preferably be offset from the horizontal so as to decline towards a drain 107. This permits excess water to flow towards drain 107. Drain 107 may be a slot, a hole, a number of slots, a number of holes, or any combination thereof. These walls 103-106, along with end walls, shown in other figures, define a cavity 108 in which the root structure and soil of the plant is held. Cavity 108 thus has an opening 109 at the top of plant container 100.

Monolithic metal plant container 100 is preferably manufactured through a molding process. A mold used to form the plant container is placed on an armature having a cup for holding molten metal. This metal is preferably aluminum. The armature is rotated to move the molten metal into the mold. The mold is then cooled so the metal hardens into the desired shape—forming the plant container. The plant container is then removed from the mold. This results in a plant container that is free of seams, as well as time consuming and unsightly welds and rivets.

While it may be possible to create a metal plant container that could effectively hold aggressive root systems through the use of bending, welding and or riveting thick metal, the resulting container is much more labor intensive and therefore more expensive to manufacture than a monolithic container. Moreover, bending, welding and riveting are often aesthetically unpleasing and would detract from the natural beauty of the plants that they would be built to contain.

The walls of monolithic metal plant container 100 defining cavity 108 should be of a suitable thickness to withstand the pressure from the growth of the root system to be contained. For instance, if monolithic metal plant container is to be constructed of aluminum and is to be used to hold bamboo, the walls defining cavity 108 should be preferably in the order of about ¼″ thick.

By way of example only, all walls in monolithic metal plant container 100 may be ¼″ thick. Monolithic metal plant container 100 may stand 1′ 10¾″ tall. The distance between the bottom of wall 101 and the bottom of wall 102 may be 1′ 9″. Opening 109 may be 8″ wide. Interior walls 103 and 104 may be 1′9½″ in tall. The bottom of drain 107 may be ½″ off the ground.

FIG. 2 shows an end view of monolithic metal plant container 100 according to an embodiment of the present invention. End wall 110 is shown enclosing one side of cavity 108. Another end wall 111 encloses the opposite side of cavity 108. End wall 110 is preferably slightly offset from the vertical towards the center, again for ease in removing the plant container from the mold. By keeping this offset to a minimum, a number of monolithic metal plant containers. 100 can be lined up in a row with so as to provide a generally continuous row of planters for creating a generally continuous row of bamboo. Interior end walls (not shown) could then be additionally provided to enclose cavity 108. As with walls 101 and 102, this would create a greater footprint for plant container 100, providing more stability. However, this would negatively affect the ability to create a continuous row of bamboo.

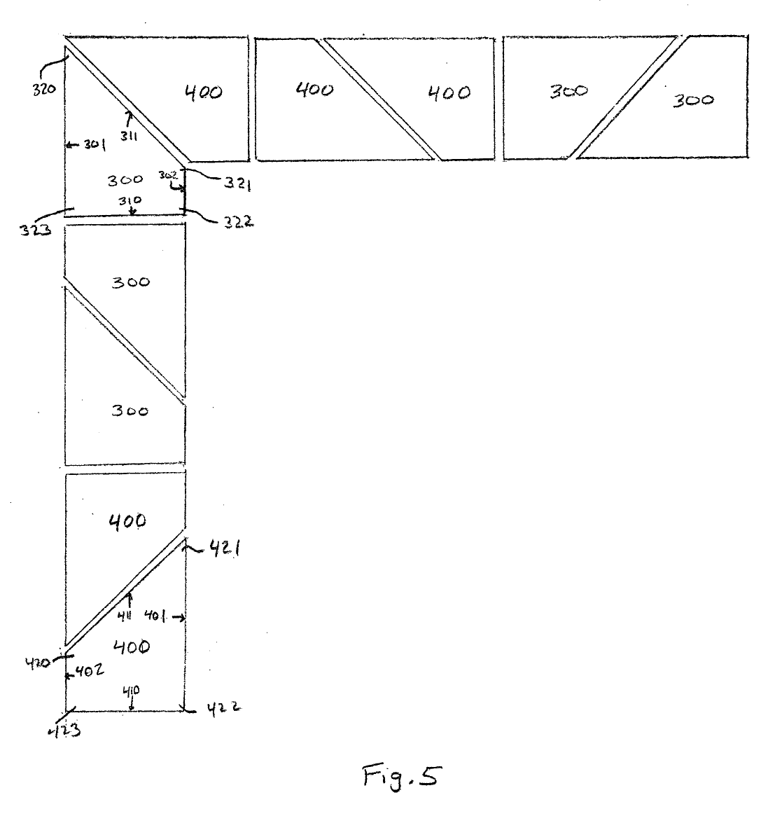

FIG. 3 shows a top view of monolithic metal plant container 100 according to an embodiment of the present invention. Exterior walls 101 and 102 are inclined toward the center, as in FIGS. 1 and 2. Interior walls 105 and 106 meet around drain 107. End walls 110 and 111 provided. Interior walls 103 and 104, end walls 110 and 111, and bottom walls 105 and 106 thus define cavity 108.

By way of example only, the length of plant container 100 may be 2′ and the width may be 1′ 9″. The drain may be a ⅛″ wide and 1′ 3″ long slot, centered along the meeting of bottom walls 105 and 106.

Referring now to FIG. 4, a sectional view of a monolithically constructed metal plant container 200 according to another embodiment of the present invention is shown. Plant container 200 is similar to plant container 100 of FIG. 1. However, instead of exterior walls 201 and 202 connecting directly to interior walls 203 and 204, they connect to top walls 220 and 221, which in turn connect to the interior walls. Also provided are bottom walls 205 and 206, drain 207 and cavity 208. End walls are also provided (although not shown in FIG. 4) as in FIGS. 2 and 3.

Referring to FIG. 5, the footprint of a plurality of monolithically constructed metal plant containers 300 and 400 arranged to form a vertical and horizontal row is shown. In this embodiment, the shape of the footprint is not rectangular as in the embodiment of FIG. 3. Instead, two different shaped plant containers 300 and 400 are arranged to form the two rows.

Plant container 300 has exterior walls 301 and 302 and end walls 310 and 311. As in the embodiments of FIGS. 1-4, exterior walls 301 and 302 are preferably offset from vertical and end walls 310 and 311 are preferably slightly offset from vertical. When one faces shorter end wall 310, longer exterior wall 301 will be on the left side and shorter exterior wall 302 will be on the right. Preferably, angle 320 is 45 degrees and angle 321 is 135 degrees, and angles 322 and 323 are both 90 degrees.

Plant container 400 also has exterior walls 401 and 402 and end walls 410 and 411. Also as in the embodiments of FIGS. 1-4, exterior walls 401 and 402 are preferably offset from vertical and end walls 410 and 411 are preferably slightly offset from vertical. However, when one faces shorter end wall 410, longer exterior wall 401 is on the right side and shorter exterior wall 402 is on the left. Preferably, angle 420 is 135 degrees and angle 421 is 45 degrees, and angles 422 and 423 are both 90 degrees.

By utilizing a combination of plant containers 300 and 400, one can create straight-lined row arrangements, zig-zag arrangements and cornered arrangements.

The interior walls, bottom walls and drains for plant containers 300 and 400 may be similar to those of the embodiments of FIGS. 1-3. Top walls, as in the embodiment of FIG. 4, may also be provided.

Although the preferred embodiments of the present invention have been described and illustrated in detail, it will be evident to those skilled in the art that various modifications and changes may be made thereto without departing from the spirit and scope of the invention as set forth in the appended claims and equivalents thereof.

For instance, container 100 may be more conically shaped, with the base footprint being more circular or elliptical in shape. This would reduce the number of exterior walls, exterior walls and bottom walls needed to as little as one. Similarly, the base footprint could be any other shape, such as triangular, square, rectangular (as shown in FIG. 3), pentagonal, etc. Another variation that could be employed would be to have walls that are not flat. For instance, walls could be curved, concave, convex, etc.

1. A metal plant container comprising:
at least one exterior wall, said at least one exterior wall at least partially forming an exterior of said plant container;
at least one interior wall connected to said at least one exterior wall;
at least one bottom wall, said at least one bottom wall being connected to said at least one interior wall, and said at least one interior wall and said at least one bottom wall at least partially forming a cavity for holding a root structure of a plant, wherein said metal plant container is monolithically constructed.

2. A metal plant container as in claim 1, further comprising at least one end wall, said at least one end wall being connected to said at least one exterior wall and forming said exterior with said at least one exterior wall and being connected to said at least one interior wall and forming said cavity with said at least one interior wall and said at least one bottom wall.

3. A metal plant container as in claim 1, wherein said at least one interior wall is connected directly to said at least one exterior wall.

4. A metal plant container as in claim 1, further comprising at least one top wall, wherein said at least one interior wall is connected to said at least one exterior wall through said at least one top wall.

5. A metal plant container as in claim 1, further comprising:
at least one slot in said at least one bottom wall, said at least one slot being constructed so as to permit drainage of excess water from said cavity.

6. A metal plant container as in claim 1, further comprising:
at least one hole in said at least one bottom wall, said at least one hole being constructed so as to permit drainage of excess water from said cavity.

7. A metal plant container comprising:
two exterior walls;
two end walls, each of said end walls being connected to each of said exterior walls, so as to form an exterior of said plant container;
two interior walls, said two interior walls being connected to said two end walls; and
two bottom walls, said two bottom walls being connected to said two end walls and said two internal walls;
wherein said two bottom walls, said two interior walls, and said two end walls form a cavity for holding a root structure of a plant and wherein said metal plant container is monolithically constructed.

8. A metal plant container as in claim 7, further comprising at least one slot, said at least one slot being constructed so as to facilitate drainage of excess water from said cavity.

9. A metal plant container as in claim 7, further comprising at least one hole, said at least one hole being constructed so as to facilitate drainage of excess water from said cavity.

10. A metal plant container as in claim 7, wherein said two exterior walls are offset from vertical.

11. A metal plant container as in claim 7, wherein said two bottom walls are offset from horizontal.

12. A metal plant container as in claim 7, wherein said two interior walls and said two end walls are slightly offset from vertical.

13. A metal plant container as in claim 7, wherein said two exterior walls are of different lengths.

14. A metal plant container as in claim 7, wherein said two end walls are of different lengths.

15. A metal plant container for a plant having an aggressive growth root system comprising:
exterior means for defining an exterior;
cavity means for defining a cavity for holding said aggressive growth root system of said plant;
connection means for connecting said exterior means to said cavity means; and
drain means for draining excess water from said cavity means, said drains means being located in said cavity means;
wherein said metal plant container is monolithically constructed.

16. A metal plant container as in claim 15, wherein said exterior means is narrower at a top portion than at a bottom portion on at least one side.

17. A metal plant container as in claim 16, wherein said connection means comprises an intersection of said exterior means and said cavity means.

18. A metal plant container as in claim 16, wherein said connection means comprises at least one top wall.
